(19) United States
(12) Patent Application Publication
(10) Pub. No.: US 2026/0159931 A1
(43) Pub. Date: Jun. 11, 2026

(54) PROPANE AS A FUEL FOR FLAME SPRAY COATING

(71) Applicant: Southwire Company, LLC, Carrollton, GA (US)

(72) Inventors: Victor Frederic Rundquist, Carrollton, GA (US); Marek Dariusz Burda, Peterborough (GB); Mark Thomas Larson, Cincinnati, OH (US)

(21) Appl. No.: 19/373,219

(22) Filed: Oct. 29, 2025

Related U.S. Application Data
(60) Provisional application No. 63/713,476, filed on Oct. 29, 2024.

(51) Int. Cl. C23C 4/11; C23C 4/129; H01B 1/02; H01B 9/00; H01B 13/00; H01B 13/32

(52) U.S. Cl. CPC C23C 4/11; C23C 4/129; H01B 1/023; H01B 13/0016; H01B 13/321; H01B 9/008

(57) ABSTRACT

Propane as a fuel for flame spray coating may be provided. First, a flame comprising oxygen and propane may be created. Next a coating material may be provided to the flame to create a flame spray. The flame spray may comprise the coating material in a melted state. Then the flame spray may be applied to a substrate.

### RELATED APPLICATION

Under provisions of 35 U.S.C. § 119(e), Applicant claims the benefit of U.S. Provisional Application No. 63/713,476, filed Oct. 29, 2024, which is incorporated herein by reference.

### BACKGROUND

Electrical conductors may be used to transmit electrical power. Such electrical conductors may comprise Aluminum Conductor Steel Reinforced (ACSR) cables. An ACSR cable is a high-capacity, high-strength stranded power cable used as electrical conductors in overhead power lines. The outer strands in an ACSR cable are aluminum. Aluminum has very good conductivity, low weight, and relatively low cost. The center strands (i.e. core) in an ACSR cable are made of steel, which provides extra strength for the ACSR cable. The lower electrical conductivity of the steel core has only a minimal effect on the overall current-carrying capacity of the cable due to the “skin effect.” With the skin effect, most of the current in an ACSR conductor is carried by the aluminum portion of the cable. Consequently, the higher resistance of the steel strands has only a small effect on the cable's overall resistance.

Electrical conductors may be rated by their current-carrying capacity. Their current-carrying capacity may be limited by a maximum operating temperature of the electrical conductor. Operating an electrical conductor at a temperature that exceeds the maximum operating temperature may impair the electrical and structural integrity of the conductor. The temperature of an electrical conductor may be influenced by current flow, solar radiation, and ambient temperature.

### BRIEF DESCRIPTION OF THE FIGURES

The accompanying drawings, which are incorporated in and constitute a part of this disclosure, illustrate various embodiments of the present disclosure. In the drawings:

FIG. 1 shows an apparatus for providing propane as a fuel for flame spray coating; and

FIG. 2 shows a method providing propane as a fuel for flame spray coating.

### DETAILED DESCRIPTION

### Overview

Propane as a fuel for flame spray coating may be provided. First, a flame comprising oxygen and propane may be created. Next a coating material may be provided to the flame to create a flame spray. The flame spray may comprise the coating material in a melted state. Then the flame spray may be applied to a substrate.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Emissivity of a surface of a material may comprise its effectiveness in emitting energy as thermal radiation. Electrical ampacity (e.g., current carrying capacity) of a conductor may be increased by increasing the emissivity of the conductor. Coating a conductor according to embodiments of the disclosure may increase the emissivity of the conductor.

Conventional flame spray coatings have been done with acetylene as the fuel and oxygen as the oxidizer. This may work because of the high flame temperature and speed of acetylene. A drawback to acetylene may be the storage and handling of the gas. Acetylene may be stored as a gas dissolved in acetone and then dispersed in a ceramic foam block, all encased in a steel pressure vessel (i.e., a bottle). This may be necessary because acetylene may be unstable and may auto ignite with pressure alone. With the process of storage and delivery of acetylene as described above, to run oxygen/acetylene torches for a long period of time (e.g., more than about 15 mins) it may be necessary to have multiple bottles. In a process of running constantly and with multiple torches, there may be as many as 200 bottles all connected together to form an adequate supply. Furthermore the acetylene gas may only be drawn off a bottle at a slower rate than actual usage. This also increases the number of bottles required. In the case of an eight torch system for example, coating processes running for 3-4 hours may need over 250 acetylene bottles to ensure stable processing.

Consistent with embodiments of the disclosure, propane may be used as an alternative fuel to acetylene. Propane may have many advantages over acetylene. First, the storage of propane may be simpler compared to acetylene. Propane may be stored in a tank as a liquid at ambient temperature at moderate pressures, for example, no more than 250 Pounds Per Square Inch (PSI). Propane gas may be drawn off the tank quickly through natural evaporation or with the use of an external vaporizer for high flow situations. The flame temperature for propane may be slightly less than acetylene, for example, 2,828 degrees Celsius for propane versus 3,160 degrees Celsius for acetylene.

Furthermore, for flame spray coating, the energy content of the fuel may be important. For example, propane has about 1.7 times the overall energy content in the flame as compared to acetylene. Moreover, the energy content of the propane flame is concentrated in the outer cone or “secondary cone”. This heat distribution may comprise a benefit for propane over acetylene because the actual melting of the coating powder may occur further away from the torch tip and the melted powder may be accelerated and may stay melted in the flame for a longer distance than with acetylene. This may allow the torch to be placed further away from the target substrate and also provide a wider coating stripe width. This may increase the efficiency of the overall system.

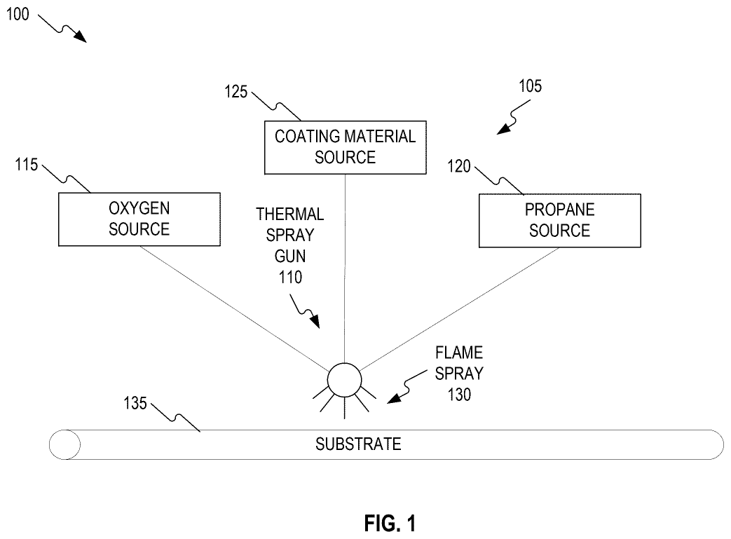

FIG. 1 shows an apparatus 100 for providing propane as a fuel for flame spray coating. As shown in FIG. 1, apparatus 100 may comprise a plurality of sources 105 and a thermal spray gun 110. Plurality of sources 105 may comprise an oxygen source 115, a propane source 120, and a coating material source 125. A flame spray 130 from thermal spray gun 110 may be applied to a substrate 135 as described in greater detail below. Consistent with embodiments of the disclosure, a plurality of thermal spray guns may be used around substrate 135. For example, four to eight thermal spray guns may be used. Embodiments of the disclosure are not limited to a certain number of thermal spray guns and any number of thermal spray guns may be used. Furthermore, substrate 135 may be moving in a production line while flame spray 130 is being applied to substrate 135. Propane source 120 may comprise, but is not limited to, a 5,000 gallon propane tank for example. Unlike acetylene, propane may not need to be stored as a gas dissolved in acetone and then dispersed in a ceramic foam block.

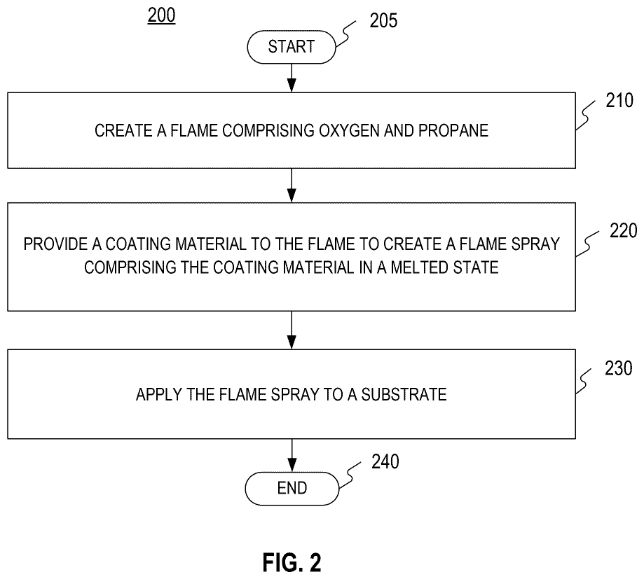

FIG. 2 is a flow chart setting forth the general stages involved in a method 200 consistent with embodiments of the disclosure for providing propane as a fuel for flame spray coating. Method 200 may be implemented using apparatus 100 for providing propane as a fuel for flame spray coating as described in more detail above with respect to FIG. 1. Ways to implement the stages of method 200 will be described in greater detail below.

Method 200 may begin at starting block 205 and proceed to stage 210 where a flame comprising oxygen and propane may be created. For example, oxygen from oxygen source 115 and propane for propane source 120 may be combined and ignited at thermal spray gun 110 to create the flame.

The standard parameters for pressures and flows may not translate from acetylene to propane. For example, more oxygen may be necessary and at higher pressures. This may also provide a benefit of increasing the flame speed. Ultimately a best flame for propane, for example, may comprise a fuel rich flame on the order of between a 2.5:1 and 3.0:1 ratio of oxygen to propane. A standard ratio for propane may comprise 4.3:1. This excess fuel may expand the secondary cone of the flame and make the coating process more efficient. Full combustion of the propane may still occur by consuming some atmospheric oxygen for example. The temperature of the flame may comprise, but is not limited to, a range between 2,200 degrees Celsius and 2,800 degrees Celsius for example.

From stage 210, where the flame comprising oxygen and propane is created, method 200 may advance to stage 220 where a coating material may be provided to the flame to create flame spray 130 comprising the coating material in a melted state. The coating material may comprise a material capable of melting without decomposition at a temperature of the flame. The coating material may comprise ceramic. For example, the coating material may comprise at least one of alumina, mullite, spinel, black titania, and copper (II) oxide. Coating material source 125 may provide the coating material as a powder. The powder may be supplied in a carrier gas comprising argon for example.

Once the coating material is provided to the flame to create flame spray 130 comprising the coating material in a melted state in stage 220, method 200 may continue to stage 230 where flame spray 130 may be applied to substrate 135. For example, substrate 135 may comprise an electrical conductor comprising, for example, a conductor comprising aluminum or an alloy thereof. Flame spray 130 may be applied to the conductor as the conductor moves in a production line. The conductor may be used for high-temperature applications. The conductor may comprise a plurality of peripheral and interior wires arranged in a concentric array that extend along a longitudinal axis of the conductor. The conductor may comprise a High Temperature Low Sag (HTLS) electrical conductor. For example, the conductor may comprise, but is not limited to, an Aluminum Conductor Steel Supported (ACSS), an Aluminum Conductor Composite Single (ACCS), a Thermal Aluminum Alloy Conductor Composite Reinforced (ZTACCR), where the aluminum alloy may comprise a high-temperature aluminum-zirconium alloy, or a Thermal Resistant Aluminum Conductor Steel Reinforced (ZTACSR). Once flame spray 130 is applied to substrate 135 in stage 230, method 200 may then end at stage 240.

An embodiment consistent with the disclosure may comprise a method for providing propane as a fuel for flame spray coating. The method may comprise creating a flame comprising oxygen and propane; providing a coating material to the flame to create a flame spray comprising the coating material in a melted state; and applying the flame spray to a substrate.

Another embodiment consistent with the disclosure may comprise an electrical conductor prepared by a process. The process may comprise creating a flame comprising oxygen and propane; providing a coating material to the flame to create a flame spray comprising the coating material in a melted state; and applying the flame spray to a substrate.

Yet another embodiment consistent with the disclosure may comprise a method for providing propane as a fuel for flame spray coating. The method may comprise creating a flame comprising oxygen and propane; providing a coating material to the flame to create a flame spray comprising the coating material in a melted state wherein the coating material comprises a ceramic material that is capable of melting without decomposition at a temperature of the flame; and applying the flame spray to an electrical conductor.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
creating a flame comprising oxygen and propane;
providing a coating material to the flame to create a flame spray comprising the coating material in a melted state; and
applying the flame spray to a substrate.

2. The method of claim 1, wherein an amount of oxygen to an amount of propane in the flame comprises a ratio in a range between of 2.5:1 and 3.0:1.

3. The method of claim 1, wherein a temperature of the flame is in a range between 2,200 degrees Celsius and 2,800 degrees Celsius.

4. The method of claim 1, wherein the coating material comprises a material capable of melting without decomposition at a temperature of the flame.

5. The method of claim 1, wherein the coating material comprises ceramic.

6. The method of claim 1, wherein the coating material comprises at least one of alumina, mullite, spinel, black titania, and copper (II) oxide.

7. The method of claim 1, wherein the coating material comprises a powder.

8. The method of claim 1, wherein providing the coating material comprises providing the coating material in a carrier gas.

9. The method of claim 8, wherein the carrier gas comprise argon.

10. The method of claim 1, wherein the substrate comprises a High Temperature Low Sag (HTLS) electrical conductor.

11. The method of claim 1, wherein the substrate comprises an Aluminum Conductor Steel Supported (ACSS) conductor.

12. The method of claim 1, wherein the substrate comprises an Aluminum Conductor Composite Single (ACCS) conductor.

13. The method of claim 1, wherein the substrate comprises a Thermal Aluminum Alloy Conductor Composite Reinforced (ZTACCR) conductor.

14. The method of claim 1, wherein the substrate comprises a Thermal Resistant Aluminum Conductor Steel Reinforced (ZTACSR) conductor.

15. The method of claim 1, wherein applying the flame spray to the substrate comprises applying the flame spray to the substrate as the substrate moves in a production line.

16. A electrical conductor prepared by a process comprising:
creating a flame comprising oxygen and propane;
providing a coating material to the flame to create a flame spray comprising the coating material in a melted state; and
applying the flame spray to the electrical conductor.

17. The electrical conductor of claim 16, wherein an amount of oxygen to an amount of propane in the flame comprises a ratio in a range between of 2.5:1 and 3.0:1.

18. The electrical conductor of claim 16, wherein a temperature of the flame is in a range between 2,800 degrees Celsius and 2,900 degrees Celsius.

19. The electrical conductor of claim 16, wherein the coating material comprises a material capable of melting without decomposition at a temperature of the flame.

20. A method comprising:
creating a flame comprising oxygen and propane;
providing a coating material to the flame to create a flame spray comprising the coating material in a melted state wherein the coating material comprises a ceramic material that is capable of melting without decomposition at a temperature of the flame; and
applying the flame spray to an electrical conductor.
